(19) United States
(12) Patent Application Publication
(10) Pub. No.: US 2022/0027986 A1
(43) Pub. Date: Jan. 27, 2022

(54) SYSTEMS AND METHODS FOR AUGMENTING DATA BY PERFORMING REJECT INFERENCE

(71) Applicant: ZestFinance, Inc., Burbank, CA (US)

(72) Inventors: Peyman Hesami, Los Angeles, CA (US); Sean Kamkar, Los Angeles, CA (US); Jerome Budzik, Los Angeles, CA (US)

(73) Assignee: ZestFinance, Inc., Burbank, CA (US)

(21) Appl. No.: 17/385,452

(22) Filed: Jul. 26, 2021

Related U.S. Application Data
(60) Provisional application No. 63/056,114, filed on Jul. 24, 2020.

(51) Int. Cl. G06Q 40/02; G06N 3/04

(52) U.S. Cl. CPC G06Q 40/025; G06N 3/0454

(57) ABSTRACT

Systems and methods for augmenting data by performing reject inference are disclosed. In one embodiment, the disclosed process trains an auto-encoder based on a subset of known labeled rows (e.g., non-default loan applicants). The process then infers labels for unlabeled rows using the auto-encoder (e.g., label some rows as non-default and some as default). The process then trains a machine learning model based on the known labeled rows and the inferred labeled rows. Applicant data is then processed by this new machine learning model to determine if a loan applicant is likely to default. If the loan applicant is not likely to default, the loan applicant is funded. For example, the loan applicant may be mailed a physical working credit card. However, if the loan applicant is likely to default, the loan applicant is rejected. For example, the loan applicant may be mailed a physical adverse action letter.

### TECHNICAL FIELD

This invention relates generally to the machine learning field, and more specifically to a new and useful system and method for developing models in the machine learning field.

### BACKGROUND

Developing a supervised machine learning model often requires access to labeled information that can be used to train the model. Labels identify values that are to be predicted by the trained model (e.g., by processing feature values included in an input data set). There is a need in the machine learning field to provide improved systems and methods for processing data used to train models.

### BRIEF DESCRIPTION OF THE FIGURES

FIGS. 1A-C are schematic representations of systems, in accordance with embodiments.

FIGS. 2A-C are schematic representations of methods, in accordance with embodiments.

FIG. 3 is a schematic representation of a labeling model, in accordance with embodiments.

FIG. 4 is a flowchart of an example process of generating explanation information associated with credit applicant in a machine learning system.

### DESCRIPTION OF THE PREFERRED EMBODIMENTS

The following description of the preferred embodiments is not intended to limit the disclosure to these preferred embodiments, but rather to enable any person skilled in the art to make and use such embodiments.

### 1. Overview

Labeled data sets are not always readily available for training machine learning models. For example, in some cases, no labels are available for a data set that is to be used for training a model. In other cases, a data set includes some labeled rows (samples), but the labeled rows form a small percentage of the rows included in the data set. For example, a data set can include 5% labeled rows and 95% unlabeled rows. If a model is trained on labeled rows that form a small percentage of the total data set, the model might behave in unreliable and unexpected manners when deployed and used in a production environment where the model is expected to make reliable predictions on new data that is more similar to the entirety (100%) of the rows.

In an example related to assessing the repayment risk of credit applications, rows in a data set represent credit applications (e.g., loan applications), and a credit scoring model is trained to predict likelihood that a borrower defaults on their loan (e.g., the model's target is a variable that represents a prediction as to whether the borrower will default on their loan). Such a credit scoring model is typically trained by using a data set of labeled rows that includes funded loan applications labeled with information identifying whether the borrower has defaulted on the loan.

However, not all loan applications are funded, for example, it is often the case that some of the loan applications are denied. In many cases, the percentage of funded applications (e.g., with proper labels related to borrower default) is often significantly less than the percentage of unfunded applications (that have no label since the applicant never received loan proceeds and became a borrower). Loan applications might not be funded for several reasons. In a first example, the loan applicant was rejected because they were deemed to be a “risky” applicant and no loan offer was made. In a second example, the loan applicant may have been made an offer but the applicant chose not to accept the loan (e.g., because of the loan terms, because the loan was no longer needed, because the applicant borrowed from another lender, etc.).

The systems and methods disclosed herein relate to generating reliable labels for the unlabeled rows (e.g., in cases where an application was made, but no loan was originated).

In examples related to medicine, data could be used to train a machine learning system to predict whether a patient is cured if they are prescribed a given course of treatment. Patients prescribed the course of treatment may not comply with the course of treatment and so the outcome (cured, uncured) would be unknown. Even if the patient does comply, they may not return to the doctor if the result of the treatment is positive, and so the actual outcome of the treatment will be unknown to the physician. The disclosure described herein can be used to make more reliable predictions in light of this missing outcome data. Many problems in predictive modeling involve data where there are missing labels and so the method and system described herein provides a useful function for many applications in the machine learning field.

The system described herein functions to develop a machine learning model (e.g., by training a new model, re-training an existing model, etc.). In some variations, at least one component of the system performs at least a portion of the method.

The method can function to develop and document a machine learning model. The method can include one or more of: accessing a data set that includes labeled rows and unlabeled rows (S210), evaluating the accessed data set (S220), optionally updating the data set (in response to the evaluation) by labeling at least one unlabeled row (S230), training a model (e.g., based on the updated data set, based on the original data set) (S240). The method can optionally include one or more of: evaluating the model performance (S250), and automatically documenting the model development process including the data augmentation methods used and the increases in performance they achieved (S260). In some variants this process is a semi-automated process in which a data scientist or statistician accesses a user interface to execute a series of steps enabled by software in order to perform the model development process incorporating labels for unlabelled rows. In other variants the method is fully automated, in other words, producing a series of models that has been enriched according to the methods disclosed herein and documented based on predetermined analyses and documentation templates. In some variants, the model being trained is a credit risk model used to evaluate creditworthiness of a credit applicant. However, the model can be any suitable type of model used for any suitable purpose. Updating the data set can include accessing additional data for at least one row in the data set, and using the accessed additional data to label at least one unlabeled row in the data set. The additional data can be accessed from any suitable data source (e.g., a credit bureau, a third party data provider, etc.) by using identifying information included in the rows (e.g., names, social security numbers, addresses, unique identifiers, e-mail addresses, phone numbers, IP addressed, etc.). In some variants, the method is automated by a software system that first identifies missing data, fetches additional data from a third party source, such as a credit bureau, updates the data set with new labels based on a set of expert rules, trains a new model variation, which is used to score successive batches of unlabeled rows generating successive iterations of the model. In some variants the method automatically generates model documentation reflecting the details of the data augmentation process and resulting model performance, and feature importances in each of the model variations. Some variations rely on a semantic network, knowledge graph, database, object store, or filesystem storage, to record inputs and outputs and coordinate the process, as is disclosed in U.S. patent application Ser. No. 16/394,651, SYSTEMS AND METHODS FOR ENRICHING MODELING TOOLS AND INFRASTRUCTURE WITH SEMANTICS, filed 25 Apr. 2019, the contents of which are incorporated herein by reference. In other variants, model feature importances, adverse action reason codes, and disparate impact analysis is conducted using a decomposition method. In some variants this decomposition method is Generalized Integrated Gradients, as described in U.S. patent application Ser. No. 16/688,789 (“SYSTEMS AND METHODS FOR DECOMPOSITION OF DIFFERENTIABLE AND NON-DIFFERENTIABLE MODELS”), filed 19 Nov. 2019, the contents of which is hereby incorporated by reference.

### 2. Benefits

Variations of this technology can afford several benefits and/or advantages.

First, by labeling unlabeled rows in a data set, previously unlabeled rows can be used to train a model. In this manner, the model can be trained to generalize more closely to rows that share characteristics with previously unlabeled rows. This often allows the model to achieve a greater level of predictive accuracy on all segments (for example, a higher AUC on both labeled and unlabeled rows). By analyzing the resulting model(s) with decomposition methods such as Generalized Integrated Gradients, variations of the present disclosure allow analysts to understand how the inclusion of unlabeled rows influences how a model generates scores by comparing the input feature importances between models with and without these additional data points. In this way an analyst may assess each model variation's safety, soundness, stability, and fairness and select the best model based on these additional attributes of each model variation. By automatically generating model risk documentation using pre-defined analyses and documentation templates, variations of the present disclosure can substantially speed up the process of reviewing each model variation that incorporates unlabeled rows.

Prior approaches to labeling unlabeled rows include applying a set of expert rules to generate inferred targets based on additional data. For example, by looking up a consumer record at a credit bureau and determining the repayment status of a similar loan made at a similar timeframe as to the row representing a loan application with a missing outcome. Such an approach, when taken alone, might only allow a small percentage of the unlabeled rows to be labeled, especially when the lending business is serving a population with limited credit history (for example, young people, immigrants, and people of color).

Other priori approaches to labeling unlabeled rows include applying Fuzzy Data Augmentation methods, where a model is built using only the labeled rows and then the trained model is used to predict the labels for the unlabeled rows. In this approach, the unlabeled rows are duplicated into two rows, one row with label 1 (Default) and one with label 1 (Non-default) and the probability of each of these outcomes is used as sample weight for these duplicated observations. These duplicated observations (alongside their corresponding sample weights) are then aggregated into the labeled samples and a new model is trained using this new data set. Such an approach might be detrimental to the performance of the model on the labeled rows specially when the trained model on the labeled rows yields close to non-deterministic results (e.g., model producing probability of 0.5 for both labels). In such cases, the unlabeled rows will be duplicated into two rows (one row with label 0 and one row with label 1), each with sample weight of 0.5, which is contradicting information for the model to learn from (e.g., two identical rows, one has label 0 and one has label 1).

Variations of the present disclosure improve upon existing techniques by implementing new methods, as well as combining other methods into a system that sequentially generates new labels based on an iterative model build process that determines whether a new label should be considered based on principled measures of model certainty, e.g., in some embodiments, by using the reconstruction error of autoencoders trained on carefully-selected subsets of the data. Any suitable measure of uncertainty may be applied to determine whether to accept an inferred label in the label assignment process.

Further benefits are provided by the system and method disclosed herein.

### 3. System

Various systems are disclosed herein. In some variations, the system can be any suitable type of system that uses one or more of artificial intelligence (AI), machine learning, predictive models, and the like. Example systems include credit systems, identity verification systems, fraud detection systems, drug evaluation systems, medical diagnosis systems, medical decision support systems, college admissions systems, human resources systems, applicant screening systems, surveillance systems, law enforcement systems, military systems, military targeting systems, advertising systems, customer support systems, call center systems, payment systems, procurement systems, and the like. In some variations, the system functions to train one or more models. In some variations, the system functions to use one or more models to generate an output that can be used to make a decision, populate a report, trigger an action, and the like.

The system can be a local (e.g., on-premises) system, a cloud-based system, or any combination of local and cloud-based systems. The system can be a single-tenant system, a multi-tenant system, or a combination of single-tenant and multi-tenant components.

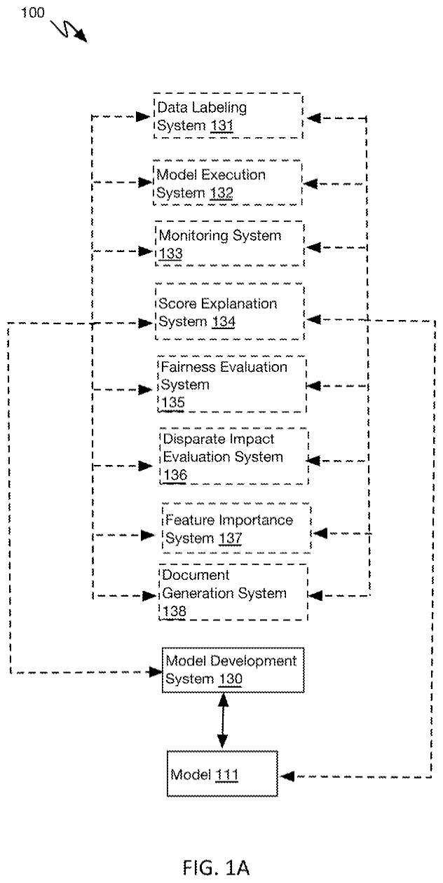

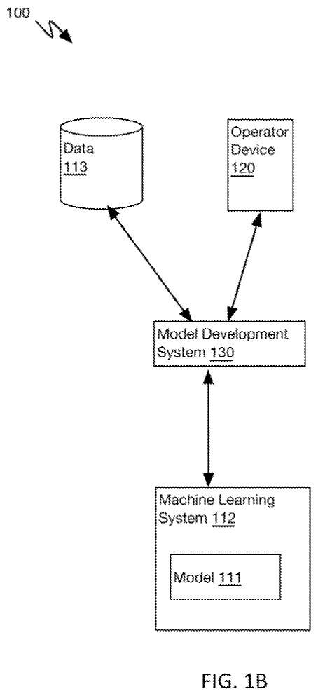

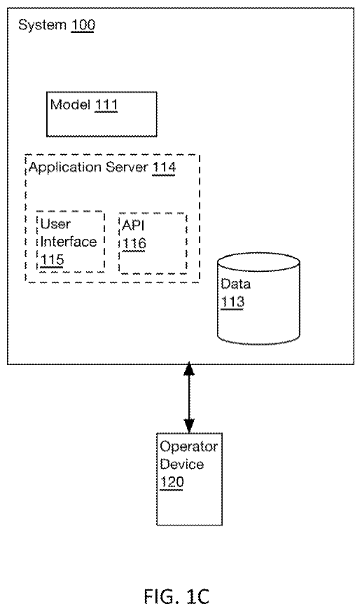

In some variations, the system (e.g., 100) functions to develop a machine learning model (e.g., by training a new model, re-training an existing model, etc.). The system includes at least a model development system (e.g., 130 shown in FIG. 1A). In some variations, at least one component of the system performs at least a portion of the method disclosed herein.

In some variations, the system (e.g., 100) includes one or more of: a machine learning system (e.g., 112 shown in FIG. 1B) (that includes one or more models); a machine learning model (e.g., 111); a data labeling system (e.g., 131); a model execution system (e.g., 132); a monitoring system (e.g., 133); a score (result) explanation system (e.g., 134); a fairness evaluation system (e.g., 135); a disparate impact evaluation system (e.g., 136); a feature importance system (e.g., 137); a document generation system (e.g., 138); an application programming interface (API) (e.g., 116 shown in FIG. 1C); a user interface (e.g., 115 shown in FIG. 1C), a data storage device (e.g., 113 shown in FIGS. 1B-C); and an application server (e.g., 114 shown in FIG. 1C). However, the system can include any suitable systems, modules, or components. The data labeling system (e.g., 131) can be a stand-alone component of the system, or can be included in another component of the system (e.g., the model development system 130).

In some variations, the model development system 130 provides a graphical user interface which allows an operator (e.g., via an operator device 120, shown in FIG. 1B) to access a programming environment and tools such as R or python, and contains libraries and tools which allow the operator to prepare, build, train, verify, and publish machine learning models. In some variations, the model development system 130 provides a graphical user interface which allows an operator (e.g., via 120) to access a model development workflow that guides a business user through the process of creating and analyzing a predictive model.

In some variations, the data labeling system 131 functions to label unlabeled rows.

In some variations, the model execution system 132 provides tools and services that allow machine learning models to be published, verified, and executed.

In some variations, the document generation system 138, includes tools that utilize a semantic layer that stores and provides data about variables, features, models and the modeling process. In some variations, the semantic layer is a knowledge graph stored in a repository. In some variations, the repository is a storage system. In some variations, the repository is included in a storage medium. In some variations, the storage system is a database or filesystem and the storage medium is a hard drive.

In some variations, the components of the system can be arranged in any suitable fashion.

FIGS. 1A, 1B and 1C show exemplary systems 100 in accordance with variations.

In some variations, one or more of the components of the system are implemented as a hardware device that includes one or more of a processor (e.g., a CPU (central processing unit), GPU (graphics processing unit), NPU (neural processing unit), etc.), a display device, a memory, a storage device, an audible output device, an input device, an output device, and a communication interface. In some variations, one or more components included in a hardware device are communicatively coupled via a bus. In some variations, one or more components included in the hardware system are communicatively coupled to an external system (e.g., an operator device 120) via the communication interface.

The communication interface functions to communicate data between the hardware system and another device (e.g., the operator device 120) via a network (e.g., a private network, a public network, the Internet, and the like).

In some variations, the storage device includes the machine-executable instructions for performing at least a portion of the method 200 described herein.

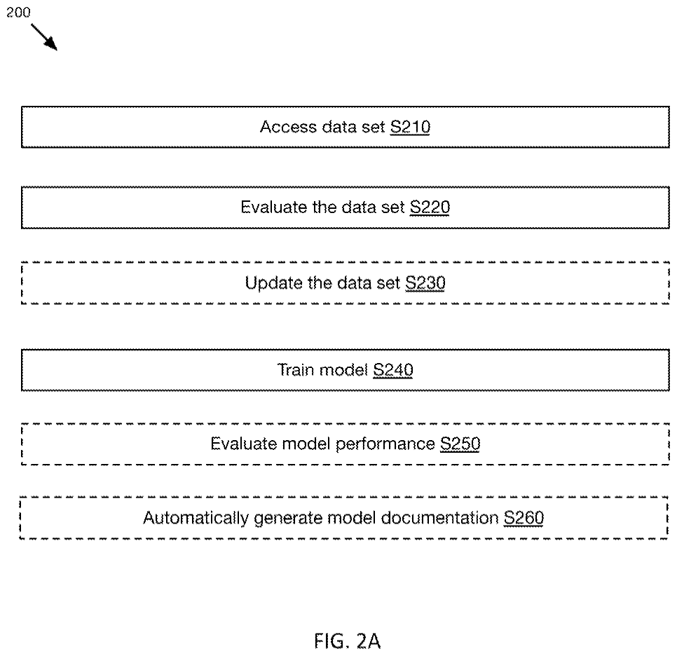

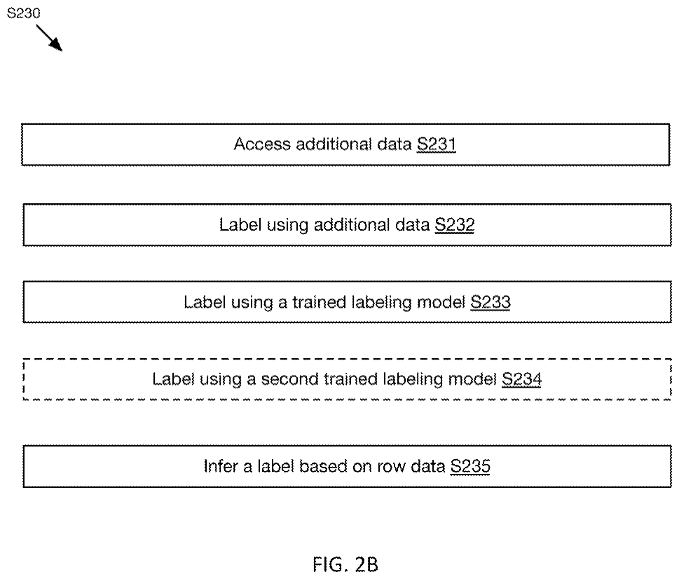

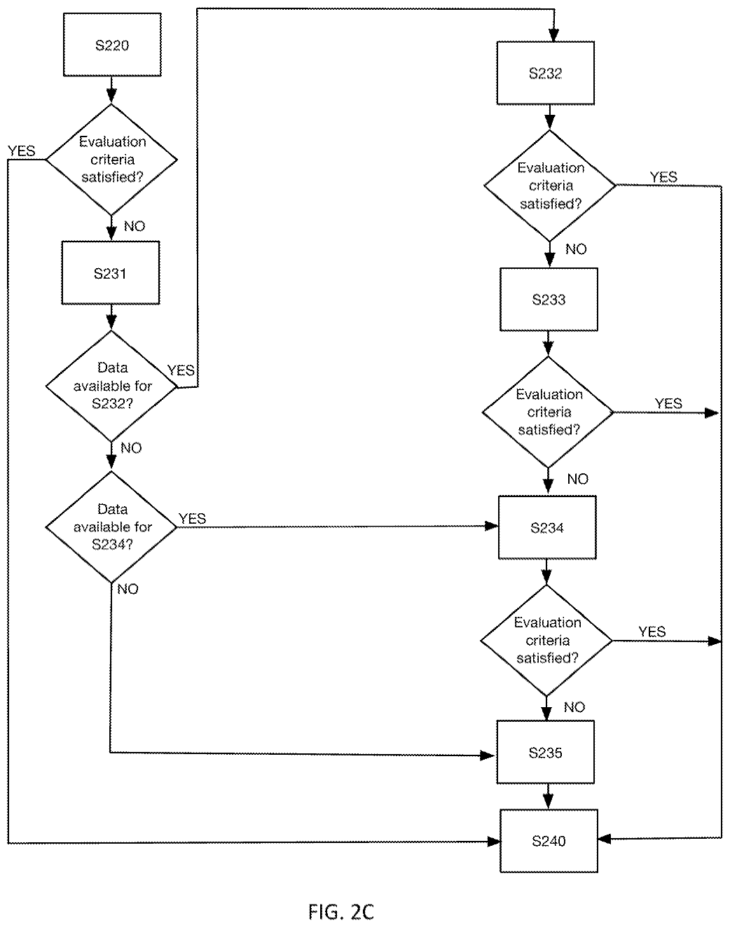

In some variations, the storage device includes data 113. In some variations, the data 113 includes one or more of training data, unlabeled rows, additional data (e.g., accessed at S231 shown in FIG. 2B), outputs of the model 111, accuracy metrics, fairness metrics, economic projections, explanation information, and the like.

The input device functions to receive user input. In some variations, the input device includes at least one of buttons and a touch screen input device (e.g., a capacitive touch input device).

### 4. Method

The method can function to develop a machine learning model. FIGS. 2A-B are representations of a method 200, according to variations.

The method 200 can include one or more of: accessing a data set that includes labeled rows and unlabeled rows S210; evaluating the accessed data set S220; updating the data set S230; training a model S240; evaluating model performance S250; and automatically generating model documentation S260. In variants, the model being trained is a credit risk model used to evaluate creditworthiness of a credit applicant. However, the model can be any suitable type of model used for any suitable purpose. In some variations, at least one component of the system 100 performs at least a portion of the method 200.

Accessing a data set S210 can include accessing the data from a local or a remote storage device. The data set can include labeled training data, as well as unlabeled data. Labeled training data includes rows that are labeled with information that is to be predicted by a model trained by using the training data. For unlabeled data, there is no label that identifies the information that is to be predicted by a model. Therefore, the unlabeled data cannot be used to train a model by performing supervised learning techniques.

The accessed data can include rows and labels representing any suitable type of information, for various types of use cases.

In a first example, rows represent patent applications, and labels identify whether the patent application has been allowed or abandoned. Labeled rows can be used to train a model (by performing supervised learning techniques) that receives input data related to a patent application, and outputs a score that identifies the likelihood that the patent application will be allowed.

In a second example, the accessed data includes rows representing credit applications. Labels for applications can include information identifying a target value for a credit scoring model that scores a credit application with a score that represents the applicant's creditworthiness. In some implementations, labels represent payment information (e.g., whether the borrower defaulted, whether the loan was paid off, etc.). Labeled rows represent approved credit applications, whereas unlabeled rows represent credit applications that were not funded (e.g., the application was rejected, the borrower declined the credit offer, etc.).

Evaluating the accessed data set S220 can include determining whether to label one or more unlabeled rows included in the accessed data set. For example, if a large percentage of rows are labeled, labeling unlabeled rows might have a minimal impact on model performance. However, if a large percentage of rows are unlabeled, it might be possible to improve model performance by labeling at least a portion of the unlabeled rows.

In variants, to determine whether to label unlabeled rows, an evaluation metric can be calculated for the accessed data set. If the evaluation metric does not satisfy evaluation criteria, then unlabeled rows are labeled, as described herein.

In variants, any suitable evaluation metric can be calculated to determine whether to label rows.

In a first variation, calculating an evaluation metric includes calculating a ratio of unlabeled rows to total rows in the accessed data set.

In a second variation, the evaluation metric quantifies a potential impact of labeling one or more of the unlabeled rows (e.g., contribution towards blind spot). For example, if the unlabeled rows are similar to the labeled rows, then labeling the unlabeled rows and using the newly labeled rows to re-train a model might not have a meaningful impact on accuracy of the model. An impact on labeling the unlabeled rows can be evaluated by quantifying (e.g., approximating) a difference between an underlying distribution of the labeled row and an underlying distribution of the unlabeled rows. In some implementations, an Autoencoder is used to approximate such a difference in underlying distributions. In an example, an autoencoder is trained by using the labeled rows, by training a neural network to recreate the inputs through a compression layer. Any suitable compression layer or Autoencoder can be used, and a grid search or bayesian search of Autoencoder hyperparameters may be employed to determine the best choice of Autoencoder hyperparameters to minimize the reconstruction error (MSE) for successive samples of labeled row inputs. The trained Autoencoder is then used to encode-decode (e.g., reconstruct) the unlabeled rows, and a mean reconstruction loss for the reconstructed unlabeled rows is identified. The mean reconstruction loss (or a difference between the mean reconstruction loss and a threshold value) can be used as the evaluation metric.

The mean reconstruction loss for an unlabeled row can be used to determine whether to count the unlabeled row when determining the blind spot. In an example, if the mean reconstruction loss for an unlabeled row is above a threshold value (e.g., maximum or 95-percentile of the reconstruction loss on the labeled rows), that unlabeled row will be counted towards contributing to the blind spots, in mathematical language:

if we define:

X_{blind spot}⊆_{recons.loss>thresh} X_{unfunded}

then:

$$blind spot score = \frac{len ( {X}_{blind spot} )}{total number of unfunded } 0 \leq score \leq 1$$

The mean reconstruction loss can also be used to compute a blind spot severity metric that quantifies the severity of the existing blind spots. In some implementations, a mean reconstruction loss of the unlabeled rows above a threshold value (e.g., maximum or 95-percentile of the reconstruction loss on the labeled rows) is used to compute the blind spot severity metric. In mathematical language:

blind spot severity=mean(recons.loss(X_{blind spot}))−thresh severity≥0

In other implementations, the Mann-Whitney U test can be performed to identify the statistical distance between the distribution of the labeled rows' reconstruction loss and the unlabeled rows' reconstruction loss, and the absolute value of the rank-biserial correlation (derived from Mann-Whitney U test statistics) can be used to quantify the severity of the blind spot. In mathematical language:

$$blind spot severity = \vert \frac{2 U}{{n}_{1} \cdot {n}_{2}} - 1 \vert$$

$$0 \leq severity \leq 1$$

where n₁ and n₂ are the size of the corresponding distributions being compared against each other.

In variants, updating the data set S230 is automatically performed in response to a determination that the evaluation metric does not satisfy the evaluation criteria (e.g., at S220). Updating the data set S230 can include labeling unlabeled rows included in the data set. In other embodiments, data augmentation is executed based on an indication of the user, and such indication is made via an operator device which displays an evaluation metric and a predetermined natural language recommendation, selected based on an evaluation metric.

In some implementations, labeling of unlabeled rows can occur in several stages, with each labeling stage optionally performing different labeling techniques. After each labeling stage, the evaluation metric is re-calculated (and compared with the evaluation criteria) to determine whether to perform a next labeling stage.

In some variations, one or more labeling stages are configured. Configuring labeling stages can include assigning a labeling technique to each labeling stage, and assigning a priority for each labeling stage. In some implementations, labeling stages are performed in order of priority until the evaluation metric is satisfied. In other embodiments, labeling is performed until a budget of time, CPU seconds, etc. is exhausted.

In an example, a first labeling technique (e.g., expert rule labeling) can be performed to update the accessed data set by labelling a first set of unlabeled rows. Thereafter, the evaluation metric can be re-calculated for the updated data set to determine if additional rows should be labeled. If the evaluation metric calculated for the updated data set fails to satisfy the evaluation metric, then a second labeling technique (e.g., model-based labeling) can be performed to further update the data set by labelling a second set of unlabeled rows. In variants, further labeling stages can be performed, to label additional rows, by performing any suitable labeling technique until the evaluation metric is satisfied.

Labeling techniques can include one or more of: labeling at least one unlabeled row by using additional data (e.g., accessed from a first data source, a second data source, etc.) (e.g., by performing an expert rule process) S232; labeling at least one unlabeled row by using a trained labeling model and the additional data S233; and labeling at least one unlabeled row by using a second trained labeling model and second additional data (e.g., accessed from a second data source) S234.

In variants, labeling techniques include training a predictive model based on the original labeled data and data generated by an expert rule process (e.g., at S232), training two Autoencoders to reconstruct different segments (e.g., segments with similar labels) of both the original labeled data and the data labeled by the expert rule process (e.g., at S232), and using these models to further label the portion of the remaining unlabeled data according to the predictive model and the MSE of the Autoencoders, which is used to measure the predictive model's uncertainty. However, any method of measuring model uncertainty may be used to select the additional labels.

Labeling techniques can optionally include inferring a label based on row data (S235). Inferring a label based on row data can include inferring a label for at least one unlabeled row by using data identified by the row (e.g., by performing Fuzzy Data Augmentation or its variants such as parceling, reweighting, reclassification, etc.) S235. Steps S232-S235 can be performed in any suitable order. In some implementations, steps S232-S235 are performed in an order identified by labeling stage configuration. Labeling stage configuration can be accessed from a storage device, received via an API, or received via a user interface. In some implementations, steps S232-S235 are performed in the following order: S232, S233, S234, S235.

In some variations, updating the data set includes accessing additional data S231. The additional data includes data related to one or more rows included in the data set accessed at S210. An identifier included in a row can be used to access the additional data (e.g., data that is stored in associated with the identifier included in the row). The identifier can be any suitable type of identifier. Example identifiers include: names, social security numbers, addresses, unique identifiers, process identifiers, e-mail addresses, phone numbers, IP addresses, hashes, public keys, UUIDs, digital signatures, serial numbers, license numbers, passport numbers, MAC addresses, biometric identifiers, session identifiers, security tokens, cookies, and bytecode. However, any suitable identifier can be used.

In variants, the additional data related to an unlabeled row can include information generated (or identified) after generation of the data included in the unlabeled row. For example, the data in the unlabeled row can be data generated at a first time T₀, whereas the additional data includes data generated after the first time (e.g., at a second time T₀₊ᵢ). For example, the data in an unlabeled row can include data available to the model development system 130 during training of a first version of the model 111. Subsequent to training of the model 111, additional data can be generated (e.g., hours, days, weeks, months, years, etc.) later, and this additional data can be used to label the previously unlabeled rows and re-train the model 111. The additional data can be generated by any suitable system (e.g., by a component of the system 100, system external to the system 100, such as a data provider, etc.).

The additional data can be accessed from any suitable source, and can include a plurality of types of data. In variants, a plurality of data sources are accessed (e.g., a plurality of credit bureaus, a third party data provider, etc.). In some variations, data sources are accessed in parallel, and the accessed data form all data sources is aggregated and used to label unlabeled rows. In some variants, data sources can be assigned to labeling stages. For example, a first labeling stage can be assigned a labeling technique that uses additional data from a first data source and a second labeling stage can be assigned a labeling technique that uses additional data from a second data source; a priority can be assigned to each of the labeling stages. In some variations, the cost of new data is used in combination with an estimate of the benefit to determine whether to acquire additional data.

In some variations, data sources are accessed in order of priority. For example, if a first data source does not include additional data for any of the rows in the data set, then a second data source is checked for the presence of additional data for at least one row (e.g., S233).

In an example, a first data source is a credit bureau, and the accessed additional data includes credit bureau information for at least one row. Accessing the credit bureau information for a row from the credit bureau can include identifying an identifier included in the row (e.g., a name, social security number, address, birthdate, etc.) and using the identifier to retrieve a credit bureau record (e.g., a credit report, etc.) that matches the identifier. However, the first data source can be any suitable data source, and the additional data can include any suitable information.

In some variations, labeling a row using accessed additional data for the row (e.g., a credit report) S232 can include performing an expert rule process. Performing an expert rule process can include evaluating one or more rules based on the accessed additional data, and generating a label based on the evaluation of at least one rule. In some implementations, performing an expert rule process for a row that represents a credit application of a borrower includes: identifying a borrower, identifying additional data (accessed at S210) for the borrower, searching the additional data of the borrower for information that relates to a loan of the borrower, and generating a label for the row by applying a rule to the searched loan information for the borrower. In some implementations, a loan type (associated with the credit application) is identified, and the borrower's additional data is searched for loan data of the same loan type as the credit application. However, additional data for other loan types can be used to generate a label for the row. In some implementations, a selected loan outcome is used to generate a label. For example, if the borrower repaid all their loans the system might assign the inferred label, “good” or “0”. In a further example, if the borrower was delinquent for long periods or defaulted on a similar loan, the system might assign the inferred label, “bad” or “1”.

In an example, for a row representing an unfunded auto loan application for a borrower in an auto lending credit risk modeling dataset, a search is performed for additional data (included in the data accessed at S210) for the borrower related to another auto loan (e.g., another auto loan originated within a predetermined amount of time from the origination date associated with the row). A label for the row can be inferred from the additional data related to the other auto loan of the borrower. For example, if the borrower defaulted on the other auto loan, then the row is labeled with a value that identifies a loan default.

In some implementations, any type of additional data for the borrower can be used to generate a label for the associated row (e.g., by applying a rule to the additional data for the borrower).

In variants, at S232, the labeled rows accessed at S210 and the labeled rows added at S232 form a first updated data set. In some variations, this updated data set is evaluated as described herein for S220. In some variations, in response to a determination that the evaluation metric calculated at S232 does not satisfy the evaluation criteria, additional labels are generated (e.g., at S233, S234, S235). In some implementations, S233 is performed before S234 and S235.

In some implementations, if the data needed to perform labeling at S232 is not available, then the process S232 is not performed, and another labeling process (e.g., S233, S234, S235) is performed (if such a process is configured).

Using a trained labeling model to label at least one unlabeled row S233 can include: training the labeling model, and generating a label for at least one unlabeled row by using the trained labeling model. Training the labeling model can include training the labeling model by using the first updated data set (which includes the labeled rows accessed at S210 and the labeled rows added at S232 by using the additional data).

In variants, additional data accessed at S231 is used to train the labeling model at S233. In some implementations, the additional data used to train the labeling model at S233 is accessed from a plurality of data sources (e.g., a first set of data sources, such as a plurality of credit bureaus). Alternatively, the additional data used to train the labeling model at S233 is accessed from a single data source (e.g., a data aggregator that aggregates data from a plurality of credit bureaus).

In some implementations, if the data needed to train the labeling model at S233 is not available, then the process S233 is not performed, and another labeling process (e.g., S234, S235) is performed (if such a process is configured).

In variants, a row of training data (used to train the labeling model) includes a labeled row included in the first updated data set, and related additional data for the row (accessed at S231) (e.g., training data=labeled_row∥additional_data). In some implementations, the related additional data includes data that is available after a time T+, which is subsequent to a time T at which the row is generated. In some implementations, the row is generated at the time T, and the additional data includes credit bureau data available after the time T+ (e.g., hours, days, weeks, months, years, etc. later). The labeling model can be any suitable type of model, such as, for example, a supervised model, a neural network, a gradient boosting machine, an unsupervised model, a semi-supervised model, or an ensemble.

In a first implementation, the labeling model is a supervised model (e.g., a Gradient Boosted Tree)

In a second implementation, the model is a semi-supervised model. In some implementations, the semi-supervised model includes one or more of a self-training model, a graph-based model, and a non-graph based model. A self-training model can include a KGB (Known Good Bad) model. In variations, the KGB model is a KGB model described in “Chapter F22) Reject Inference”, by Raymond Albert Anderson, published December 2016, available at https://www.researchgate.net/publication/311455053 Chapter F22 Reject Inference/link/5cdaf70b458515712eab5ffe/download, the contents of which is hereby incorporated by reference. A KGB model can include Fuzzy Data Augmentation based models or its variants such as Hard Cutoff model, Parceling, etc.

In some implementations, the semi-supervised method includes training two Autoencoders separately on two classes (Default and non-Default). Then these two Autoencoders are used to score the unlabeled rows. Based on the two scores from these two Autoencoders, a determination can be made as to whether an unlabeled row is more similar to the Default class (label 0) or the non-Default class (label 1). Those rows that are most similar to the Default class are assigned an inferred label 0 (that infers the row as being most similar to the Default class), and rows that are most similar to non-Default classes classes can be assigned a label 1 (that infers that the row is most similar to the non-Default class). In mathematical language shown below in Equation 1:

$$y = \{ \begin{matrix}1 & if AE 0. loss ( X ) - AE 1. loss ( x ) > 0 \\ 0 & o . w .\end{matrix}$$

where AE₀ is the Autoencoder trained on the Default class (e.g., segments of labeled populations with label 0) and AE₁ is the Autoencoder trained on the non-Default class (e.g., segments of labeled populations with label 1) y. As shown in Equation 1, if the reconstruction loss for the label 0 Autoencoder AE₀ is greater than the reconstruction loss of the label 1 Autoencoder AE₁, then the row is assigned label 1. Otherwise, the row is assigned label 0.

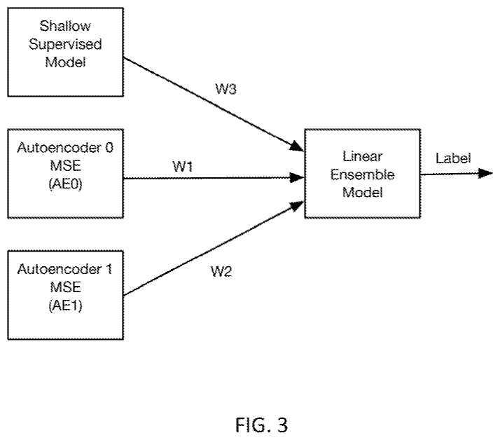

In a third implementation, the labeling model is an ensemble of a weak supervised model (e.g., a shallow gradient boosted tree) and the semi-supervised model explained above. In an example, this ensemble is a linear ensemble of the shallow supervised model and the reconstruction error losses from the two trained Autoencoders as shown in FIG. 3.

In variants, the weights shown in FIG. 3 (W₁, W₂, W₃) are systematically calculated as:

W1∝Relu(max(AE0.loss(X))−mean(AE0.loss(X)))

W2∝Relu(max(AE1.loss(X))−mean(AE1.loss(X)))

W3∝1−(w1+w2)

Where Relu is the Rectified Linear Unit function. In other examples, the ensemble is a non-linear ensemble of these three models (e.g., by using a supervised Gradient Boosted Tree model, deep neural network, or other model which produces a score based on sub-model inputs). It will be appreciated by practitioners that any suitable method of combining labeling models may be used, using any reasonable composition of computable functions, and that any number of labeling models (supervised or unsupervised) and labeling model variations (for example, different auto encoder variations) may be combined using the methods described herein.

In a fourth implementation, the labeling model is an unsupervised model (e.g., clustering based, anomaly based, autoencoder, etc.).

Generating a label for a row by using the trained labeling model includes providing the unlabeled row and related additional data for the row (accessed at S231) as input to the trained labeling model, and executing the labeling model to generate the label for the row (e.g., input=unlabeled_row∥additional_data).

In variants, at S233, the labeled rows accessed at S210, the labeled rows added at S232, and the labeled rows added at S233 form a second updated data set. In some variations, this second updated data set is evaluated as described herein for S220. In some implementations, in response to a determination that the evaluation metric calculated at S233 does not satisfy the evaluation criteria, additional labels are generated (e.g., at S234, S235). In some implementations, S234 is performed before S235.

Using a second trained labeling model to label at least one unlabeled row S234 can include: training the second labeling model, and generating a label for at least one unlabeled row by using the trained second labeling model. If labeling is performed at S232 and S233, then training the second labeling model includes training the second labeling model by using the second updated data set, and additional data accessed at S231. If labeling is not performed at S232 and S233 (e.g., the required data was not available), then training the second labeling model includes training the second labeling model by using labeled rows accessed at S210 and additional data accessed at S231.

In some implementations, the additional data used to train the second labeling model at S234 is accessed from a second set of one or more data sources that is different from the set of data sources used to train the labeling model at S233. For example, credit bureau data can be used to train the labeling model at S233, whereas data from a third party data provider (e.g., LexisNexis) is used to train the second labeling mode at S234. The second labeling model can be used to generate a label for unlabeled rows that do not have a first type of additional data, but that do have a second type of additional data. For example, if there is no relevant credit data for a row, other data (e.g., data related to payment of phone bills, frequency of phone number changes, etc.) can be used to generate a label for the row.

In some implementations, if the data needed to train the second labeling model at S234 is not available, then the process S234 is not performed, and another labeling process (e.g., S235) is performed (if such a process is configured).

In variants, a row of training data (used to train the second labeling model) includes a labeled row included in the second updated data set, and related additional data for the row (accessed at S231) (e.g., training data=labeled_row∥additional_data). The additional data used to train the second labeling model can be of a different type or from a different source as compared to the additional data used to train the labeling model at S233.

The second labeling model can be any suitable type of model, such as, for example, a supervised model, an unsupervised model, a semi-supervised model, or an ensemble.

In a first implementation, the second labeling model is a supervised model. In a second implementation, the second labeling model is a semi-supervised model (as described herein for S233). In a third implementation, the second labeling model is an ensemble of a supervised model and a semi-supervised model. In a fourth implementation, the second labeling model is an unsupervised model (e.g., clustering based, anomaly based, autoencoder, etc.).

Generating a label for a row by using the trained second labeling model includes providing the unlabeled row and related additional data for the row (accessed at S231) as input to the trained second labeling model, and executing the second labeling model to generate the label for the row (e.g., input=unlabeled_row∥additional_data). Additional data used to label the row is from the same source and of the same type as the additional data used to train the second labeling model.

In variants, at S234, the labeled rows accessed at S210, the labeled rows added at S232, the labeled rows added at S233, and the labeled rows added at S234 form a third updated data set. In some variations, this third updated data set is evaluated as described herein for S220. In some implementations, in response to a determination that the evaluation metric calculated at S234 does not satisfy the evaluation criteria, additional labels are generated (e.g., at S235).

Inferring a label S235 can include: by performing one or more of fuzzy data augmentation, delta probability, parceling, reweighting, reclassification. Data accessed at S210 and S231 can be used to infer a label for an unlabeled row at S235.

In variants, at S235, the labeled rows accessed at S210, the labeled rows added at S232, the labeled rows added at S233, the labeled rows added at S234, and the labeled rows added at S235 form a fourth updated data set. In some variations, this fourth updated data set is evaluated as described herein for S220.

In variants, training a model S240 includes training a model using labeled rows accessed at S210, and any unlabeled rows that are labeled at S230. The model trained at S240 is preferably different from any labeling models trained at S230. However, any suitable model can be trained at S240.

In some variations, the model trained at S240 is evaluated by using a fairness evaluation system 135. For example, inferring labels at S235 might introduce biases into the model, such that the model treats certain classes of data sets differently than other classes of data sets. To reduce this bias, features can be removed from training data (or feature weights can be adjusted), and the model can be retrained until the effects of such model biases are reduced.

The biases inherent in such a model can be compared against fairness criteria. In some implementations, if the model trained at S240 does not satisfy fairness criteria, one or model features are removed from the training data (or features weights are adjusted), and the model is retrained and evaluated for fairness. Features can be removed, and the model can be retrained, until fairness criteria has been satisfied. Training the model to improve fairness can be performed as described in U.S. patent application Ser. No. 16/822,908, filed 18 Mar. 2020 (“SYSTEMS AND METHOD FOR MODEL FAIRNESS”), the contents of which is hereby incorporated by reference.

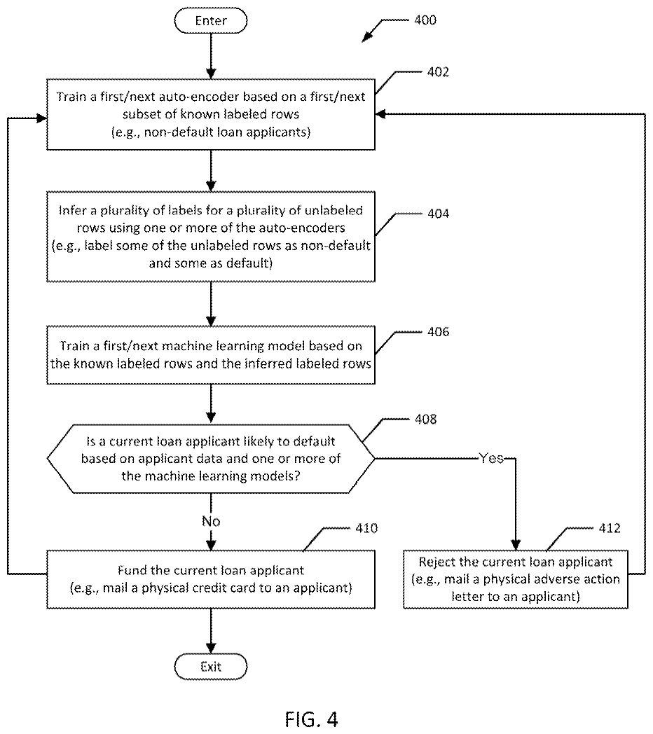

FIG. 4 is a flowchart of an example process of generating explanation information associated with credit applicant in a machine learning system. Although the process 300 is described with reference to the flowchart illustrated in FIG. 4, it will be appreciated that many other methods of performing the acts associated with process 400 may be used. For example, the order of many of the operations may be changed, and some of the operations described may be optional.

In this example, the process 400 begins by training an auto-encoder based on a subset of known labeled rows (block 402). For example, each of the rows may represent a non-default loan applicant. The process 400 then infers labels for unlabeled rows using the auto-encoder(s) (block 404). For example, the process 400 may label some of the unlabeled rows as non-default and some as default. The process 400 then trains a machine learning model based on the known labeled rows and the inferred labeled rows (block 406).

Applicant data is then processed by this new machine learning model to determine if a loan applicant is likely to default (block 408). If the loan applicant is not likely to default, the loan applicant is funded (block 410). For example, the loan applicant may be mailed a physical working credit card. However, if the loan applicant is likely to default, the loan applicant is rejected (block 412). For example, the loan applicant may be mailed a physical adverse action letter. In either event, the process preferably loops back to block 402 to repeat the process with this additional labeled row.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

In summary, persons of ordinary skill in the art will readily appreciate that methods and apparatus for augmenting data by performing reject inference have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of funding a loan, the method comprising:
training a first auto-encoder based on a first subset of a plurality of labeled rows, wherein the first subset primarily includes rows indicative of non-default loan applicants;
inferring a first label for a first unlabeled row using the first auto-encoder;
training a first machine learning model based on the plurality of labeled rows, the first unlabeled row, and the first inferred label; and
funding a first loan based on the first machine learning model.

2. The method of claim 1, further comprising:
training a second auto-encoder based on a second subset of the plurality of labeled rows, wherein the second subset primarily includes rows indicative of default loan applicants;
inferring a second label for a second unlabeled row using the first auto-encoder and the second auto-encoder;
training a second machine learning model based on the plurality of labeled rows, the second unlabeled row, and the second inferred label; and
funding a second loan based on the second machine learning model.

3. The method of claim 1, wherein training the first auto-encoder includes training a neural network to recreate inputs through a compression layer.

4. The method of claim 3, further comprising employing a grid search of hyper parameters associated with the first auto-encoder to minimize reconstruction error.

5. The method of claim 3, further comprising employing a Bayesian search of hyper parameters associated with the first auto-encoder to minimize reconstruction error.

6. The method of claim 1, further comprising:
evaluating the first machine learning model using a fairness evaluation system;
determining if the first machine learning model meets a fairness criteria; and
adjusting the first machine learning model to meet the fairness criteria.

7. The method of claim 1, further comprising:
training a second machine learning model based on a plurality of labeled rows indicative of the plurality of funded loan applicants;
evaluating a first performance of the first machine learning model;
evaluating a second performance of the second machine learning model; and
comparing the first performance and the second performance to document an improved machine learning model.

8. A method of funding a loan, the method comprising:
training a first auto-encoder based on a first subset of a plurality of labeled rows, wherein the first subset primarily includes rows indicative of non-delinquent loan applicants;
inferring a first label for a first unlabeled row using the first auto-encoder;
training a first machine learning model based on the plurality of labeled rows, the first unlabeled row, and the first inferred label; and
funding a first loan based on the first machine learning model.

9. An apparatus for funding a loan, the apparatus comprising:
a processor;
an inout device operatively coupled to the processor;
an output device operatively coupled to the processor; and
a memory device operatively coupled to the processor, the memory device storing data and instructions to:
train a first auto-encoder based on a first subset of a plurality of labeled rows, wherein the first subset primarily includes rows indicative of non-default loan applicants;
infer a first label for a first unlabeled row using the first auto-encoder;
train a first machine learning model based on the plurality of labeled rows, the first unlabeled row, and the first inferred label; and
fund a first loan based on the first machine learning model.

10. The apparatus of claim 9, wherein the instructions are further structured to:
train a second auto-encoder based on a second subset of the plurality of labeled rows, wherein the second subset primarily includes rows indicative of default loan applicants;
infer a second label for a second unlabeled row using the first auto-encoder and the second auto-encoder;
train a second machine learning model based on the plurality of labeled rows, the second unlabeled row, and the second inferred label; and
fund a second loan based on the second machine learning model.

11. The apparatus of claim 9, wherein training the first auto-encoder includes training a neural network to recreate inputs through a compression layer.

12. The apparatus of claim 11, wherein the instructions are further structured to employ a grid search of hyper parameters associated with the first auto-encoder to minimize reconstruction error.

13. The apparatus of claim 11, wherein the instructions are further structured to employ a Bayesian search of hyper parameters associated with the first auto-encoder to minimize reconstruction error.

14. The apparatus of claim 9, wherein the instructions are further structured to:
evaluate the first machine learning model using a fairness evaluation system;
determine if the first machine learning model meets a fairness criteria; and
adjust the first machine learning model to meet the fairness criteria.

15. The apparatus of claim 9, wherein the instructions are further structured to:
train a second machine learning model based on a plurality of labeled rows indicative of the plurality of funded loan applicants;
evaluate a first performance of the first machine learning model;
evaluate a second performance of the second machine learning model; and
compare the first performance and the second performance to document an improved machine learning model.
